(19) United States
(12) Patent Application Publication
(10) Pub. No.: US 2014/0226094 A1
(43) Pub. Date: Aug. 14, 2014

(54) DISPLAY PANEL, 3-D DISPLAY APPARATUS, AND DISPLAY METHOD BASED ON SEGMENTED PARALLAX BARRIERS

(71) Applicant: Electronics and Telecommunications Research Institute, Daejeon-si (KR)

(72) Inventors: Hyun LEE, Daejeon-si (KR); Eung Don LEE, Daejeon-si (KR)

(73) Assignee: Electronics and Telecommunications Research Institute, Daejeon-si (KR)

(21) Appl. No.: 13/950,462

(22) Filed: Jul. 25, 2013

(30) Foreign Application Priority Data
Feb. 14, 2013 (KR) 10-2013-0015747

(51) Int. Cl. G02B 27/22; G02F 1/1335

(52) U.S. Cl. CPC G02B 27/2214; G02F 1/1335
USPC 349/15

(57) ABSTRACT

A display panel based on a segmented parallax barrier according to the present invention includes the segmented parallax barrier disposed in a front or back of an image panel and configured to block a specific part of an image displayed through the image panel and wherein the segmented parallax barrier is configured to connect fine transparent electrodes belonging to an identical group through a transparent electrode, from among fine transparent electrodes grouped in specific patterns, so that voltage is supplied to the fine transparent electrodes without an additional feed line assigned to each fine transparent electrode. Accordingly, the production cost of a TN-LCD panel based on a segmented parallax barrier can be reduced, and a TN-LCD panel having excellent barrier pattern characteristics can be easily manufactured.

This application claims the benefit of priority of Korean Patent Application No. 10-2013-0015747 filed on Feb. 14, 2013, which is incorporated by reference in its entirety herein.

### BACKGROUND OF THE INVENTION

1. Field of the Invention

The present invention relates to a segmented parallax barrier structure and, more particularly, to a segmented parallax barrier structure for lowering the production cost of a segmented parallax barrier and improving the characteristics of a Twisted Nematic Liquid Crystal Display (TN-LCD) panel.

2. Discussion of the Related Art

In relation to an autostereoscopic 3-D display method, F. E Ives in U.S.A. suggested a parallax stereogram in which left and right images are alternately disposed on the rear of a parallax barrier at specific intervals so that the left and right images are separated from each other in order to view a stereoscopic image in 1903. More particularly, a 3-D display method using parallax barriers is technology in which vertical slits configured to have a slim and stripe pattern and to transmit or block light are arranged at specific intervals and left and right images are alternately disposed at specific intervals in front or in the rear of the vertical slits. Accordingly, when viewing an image through the slits at a specific view, a person can feel a 3-D effect because the left and right images are precisely separated from each other geometrically. That is, if a parallax barrier optical plate having a stripe pattern and functioning as special glasses is installed in front of a monitor screen, a user can perceive a stereoscopic image even without wearing glasses.

Segmented parallax barrier technology is technology in which a transparent electrode for forming a barrier is split into a plurality of fine transparent electrodes and the fine barrier electrodes are combined and driven depending on the location of a user in order to provide a wide viewing angle. The segmented parallax barrier technology is disclosed in Korean Patent Laid-Open Publication No. 10-2007-0023849 (Filing No. 10-2005-0078122). In this segmented parallax barrier, a line must be provided in the fine transparent electrode because the barrier must be controlled by applying voltage across the fine transparent electrode, and it is difficult to wire the fine transparent electrode in the thin and long space of a thin panel.

### SUMMARY OF THE INVENTION

An object of the present invention to provide a display panel, a 3-D display apparatus, and a display method based on segmented parallax barriers which are capable of reducing manufacturing costs and also improving the characteristics of a Twisted Nematic Liquid Crystal Display (TN-LCD) panel by uniformly forming barrier patterns.

In accordance with an embodiment of the present invention, a display panel based on a segmented parallax barrier includes the segmented parallax barrier disposed in the front or back of an image panel and configured to block a specific part of an image displayed through the image panel and fine transparent electrodes included in the segmented parallax barrier and grouped in specific patterns, wherein fine transparent electrodes belonging to the same group may be connected so that voltage is supplied to the fine transparent electrodes without an additional feed line included in each fine transparent electrode.

The segmented parallax barrier may include an upper substrate configured to include fine transparent electrodes having a first pattern and a second pattern and to have the fine transparent electrodes of the first pattern connected to a first feed line and have the fine transparent electrodes of the second pattern connected to a second feed line, a lower substrate configured to include fine transparent electrodes having a third pattern and a fourth pattern and to have the fine transparent electrodes of the third pattern connected to a third feed line and have the fine transparent electrodes of the fourth pattern connected to a fourth feed line, and a liquid crystal layer disposed between the upper and lower substrates.

The first to the fourth feed lines may be connected to both ends of the display panel on the left and right sides.

The first pattern and the second pattern may belong to different groups, and the third pattern and the fourth pattern may belong to different groups.

The fine transparent electrodes may be made of patterned Indium Tin Oxide (ITO).

The segmented parallax barrier may operate in normally white mode in which the liquid crystal layer of the segmented parallax barrier blocks light when voltage is supplied to the fine transparent electrode.

The segmented parallax barrier may operate in normally black mode in which the liquid crystal layer of the segmented parallax barrier transmits light when voltage is supplied to the fine transparent electrode.

In accordance with another embodiment of the present invention, a 3-D display apparatus based on a segmented parallax barrier includes an image panel configured to display a left image and a right image so that left image columns and right image columns are alternately displayed, the segmented parallax barrier disposed in the front or back of the image panel and configured to block a specific part of a displayed image, and a driving unit configured to drive the segmented parallax barrier based on the distance between the image panel and a viewer so that the left image and the right image are separately viewed, wherein the segmented parallax barrier is configured to connect fine transparent electrodes belonging to an identical group through a transparent electrode, from among fine transparent electrodes grouped in specific patterns, so that voltage is supplied to the fine transparent electrodes without an additional feed line.

The segmented parallax barrier may include an upper substrate configured to include fine transparent electrodes having a first pattern and a second pattern and to have the fine transparent electrodes of the first pattern connected to a first feed line and have the fine transparent electrodes of the second pattern connected to a second feed line, a lower substrate configured to include fine transparent electrodes having a third pattern and a fourth pattern and to have the fine transparent electrodes of the third pattern connected to a third feed line and have the fine transparent electrodes of the fourth pattern connected to a fourth feed line, and a liquid crystal layer disposed between the upper and lower substrates.

The first to the fourth feed lines may be connected to both ends of a display panel on the left and right sides which includes the segmented parallax barrier.

In accordance with another embodiment of the present invention, a display method based on a segmented parallax barrier includes a driving unit driving the segmented parallax barrier and the segmented parallax barrier blocking a specific part of a displayed image under control of the driving unit, wherein the segmented parallax barrier is configured to connect fine transparent electrodes belonging to an identical group through a transparent electrode, from among fine transparent electrodes grouped in specific patterns, so that voltage is supplied to the fine transparent electrodes without an additional feed line.

The segmented parallax barrier may include an upper substrate configured to include fine transparent electrodes having a first pattern and a second pattern and to have the fine transparent electrodes of the first pattern connected to a first feed line and have the fine transparent electrodes of the second pattern connected to a second feed line, a lower substrate configured to include fine transparent electrodes having a third pattern and a fourth pattern and to have the fine transparent electrodes of the third pattern connected to a third feed line and have the fine transparent electrodes of the fourth pattern connected to a fourth feed line, and a liquid crystal layer disposed between the upper and lower substrates.

The first to the fourth feed lines may be connected to both ends of the display panel on the left and right sides.

The first pattern and the second pattern may belong to different groups, and the third pattern and the fourth pattern may belong to different groups.

The fine transparent electrodes may be made of patterned Indium Tin Oxide (ITO).

The segmented parallax barrier blocking a specific part of a displayed image under control of the driving unit may include driving the segmented parallax barrier in normally white mode in which the liquid crystal layer of the segmented parallax barrier blocks light when voltage is supplied to the fine transparent electrode.

The segmented parallax barrier blocking a specific part of a displayed image under control of the driving unit may include driving the segmented parallax barrier in normally black mode in which the liquid crystal layer of the segmented parallax barrier transmits light when voltage is supplied to the fine transparent electrode.

In accordance with yet another embodiment of the present invention, a 3-D display method based on a segmented parallax barrier includes an image panel displaying a left image and a right image so that left image columns and right image columns are alternately displayed, a driving unit driving the segmented parallax barrier based on the distance between the image panel and a viewer so that the left image and the right image are separately viewed, and the segmented parallax barrier blocking a specific part of the displayed image under control of the driving unit, wherein the segmented parallax barrier is configured to connect fine transparent electrodes belonging to an identical group through a transparent electrode, from among fine transparent electrodes grouped in specific patterns, so that voltage is supplied to the fine transparent electrodes without an additional feed line.

The segmented parallax barrier may include an upper substrate configured to include fine transparent electrodes having a first pattern and a second pattern and to have the fine transparent electrodes of the first pattern connected to a first feed line and have the fine transparent electrodes of the second pattern connected to a second feed line, a lower substrate configured to include fine transparent electrodes having a third pattern and a fourth pattern and to have the fine transparent electrodes of the third pattern connected to a third feed line and have the fine transparent electrodes of the fourth pattern connected to a fourth feed line, and a liquid crystal layer disposed between the upper and lower substrates.

The first to the fourth feed lines may be connected to both ends of a display panel on the left and right sides which may include the segmented parallax barrier.

### BRIEF DESCRIPTION OF THE DRAWINGS

FIG. 1 is a block diagram showing the construction of a conventional 3-D display apparatus based on multi-layered parallax barriers;

FIG. 2 is a block diagram showing a conventional display apparatus based on segmented parallax barriers that supports 3Ds;

FIG. 3 is a block diagram showing the structure of fine transparent electrodes for forming a segmented parallax barrier in accordance with an embodiment of the present invention;

FIG. 4 is a diagram illustrating a case where TN-LCs operate in normally white mode;

FIG. 5 is a diagram illustrating a case where TN-LCs operate in normally black mode;

FIG. 6 is a flowchart illustrating a display method of the segmented parallax barrier structure in accordance with an embodiment of the present invention; and

FIG. 7 is a flowchart illustrating a 3-D display method of the segmented parallax barrier structure in accordance with an embodiment of the present invention.

### DETAILED DESCRIPTION OF THE EMBODIMENTS

The present invention may be modified in various ways and may be implemented to have several embodiments. Specific embodiments of the present invention are illustrated in the drawings and are described in detail in the detailed description.

It is however to be noted that the present invention is not intended to be limited to the specific embodiments, but is intended to include all modifications, equivalents, or substitutions which fall within the spirit and technical scope of the present invention.

Terms, such as the first and the second, may be used to describe various elements, but the elements should not be restricted by the terms. The terms are used to only distinguish one element and the other element from each other. For example, a first element may be named a second element without departing from the scope of the present invention. Likewise, a second element may be named a first element. A term, such as and/or, includes a combination of a plurality of pertinent and described items or any one of a plurality of pertinent and described items.

When it is said that one element is ‘connected’ or ‘coupled’ with the other element, it should be understood that one element may be directly connected or coupled with the other element, but a third element may exist between the two elements. In contrast, when it is said that one element is ‘directly connected’ or ‘directly coupled’ with the other element, it should be understood that a third element does not exist between the two elements.

The terms used in this application are used to only describe specific embodiments and are not intended to restrict the present invention. An expression of the singular number includes an expression of the plural number unless clearly defined otherwise in the context. In this application, terms, such as ‘comprise’ or ‘have’, are intended to designate that characteristics, numbers, steps, operations, elements, or parts which are described in the specification, or a combination of them exist, and should not be understood that they exclude the existence or possible addition of one or more other characteristics, numbers, steps, operations, elements, parts, or combinations of them in advance.

All terms used herein, including technical or scientific terms, have the same meanings as those that are typically understood by those skilled in the art, unless otherwise defined. Terms, such as ones defined in common dictionaries, should be constructed as having the same meanings as those in the context of related technology and should not be constructed as having ideal or excessively formal meanings, unless clearly defined in the specification.

Hereinafter, some exemplary embodiments of the present invention will be described in detail with reference to the accompanying drawings. In describing the present invention, in order to help general understanding, the same reference numerals designate the same elements throughout the drawings and a redundant description of the same elements is omitted.

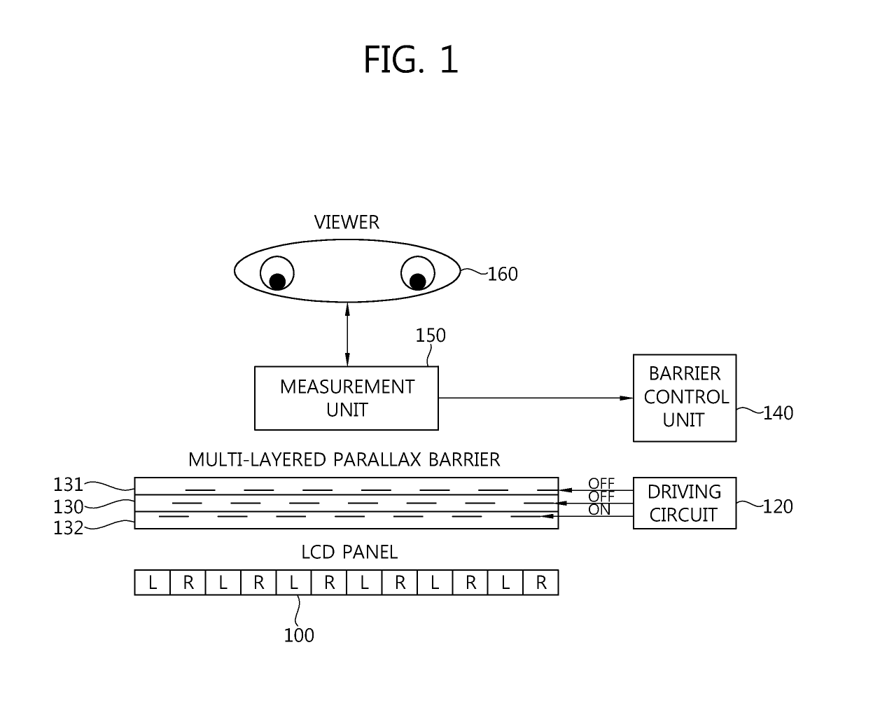

FIG. 1 is a block diagram showing the construction of a conventional 3-D display apparatus based on multi-layered parallax barriers. As shown in FIG. 1, in the conventional 3-D display apparatus based on multi-layered parallax barriers, multi-layered parallax barriers 130 to 132 are joined over an LCD panel 100, and a method of controlling a viewing distance and a viewing angle in an autostereoscopic 3-D display by driving only the barrier 132 corresponding to the viewing distance of a viewer 160 and turning off the remaining barriers is used.

Referring to FIG. 1, the 3-D display apparatus based on multi-layered parallax barriers may include a measurement unit 140 for measuring the distance between the viewer 160 and a display, left and right locations, and a slope, a barrier control unit 140 for selecting and controlling a parallax barrier to be driven in response to the measured signal, the multi-layered parallax barriers 130 to 132, a driving circuit 120 for driving the barriers in response to a signal from the barrier control unit 140, and the LCD panel 100.

First, a measurement sensor and a camera for measuring the distance between the viewer and the display and left and right locations can be used as the measurement unit 140. A common sensor and camera, such as an IR sensor, ultrasonic waves, a laser, a 2-D camera, and a stereo camera, can be used. The barrier control unit 140 selects a barrier (e.g., 132) to be driven from the multi-layered parallax barriers 130 to 132 based on pieces of information about the location of the viewer received from the measurement unit 140, such as the distance and the left and right locations, depending on a barrier design method. The driving circuit 120 turns on only the selected barrier 132 and turns off the remaining barriers.

In the 3-D display apparatus based on the multi-layered parallax barrier, however, in order to continuously control the operation of a 3-D display according to a change in the location of a user from the 3-D display, several parallax barriers are necessary. Accordingly, fabrication is not easy and expenses for the fabrication are high.

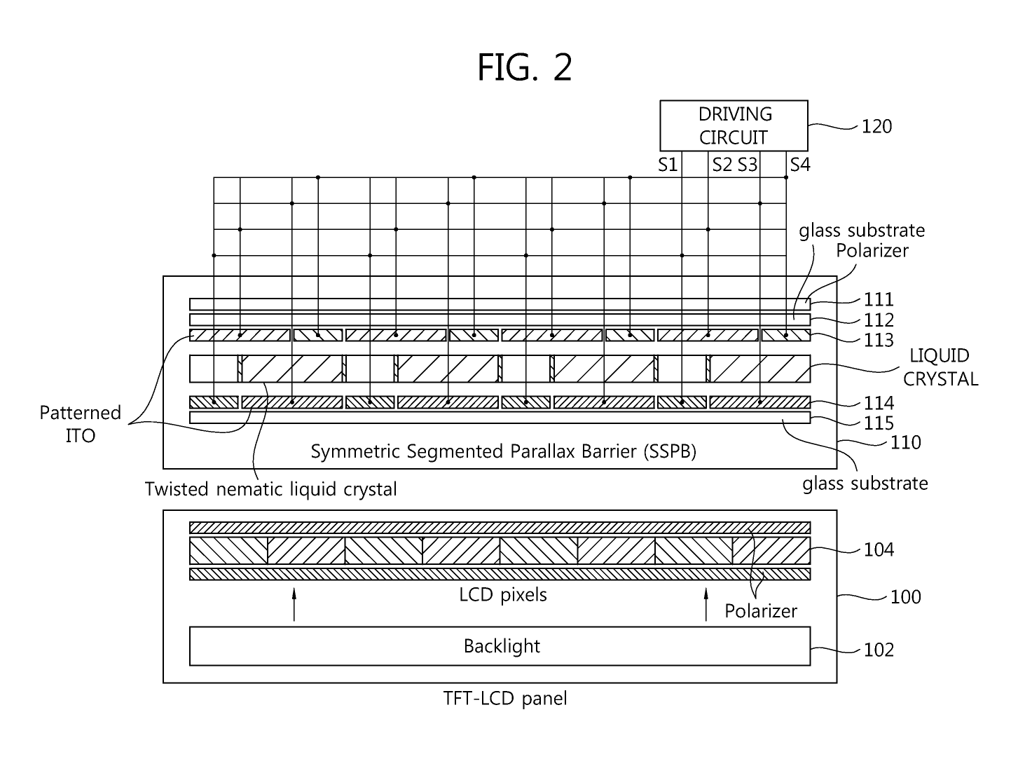

FIG. 2 is a block diagram showing a conventional display apparatus based on segmented parallax barriers that supports 3Ds. The conventional display apparatus based on 3-D segmented parallax barriers may include a TFT-LCD panel 100, a TN-LCD panel 110, and a driving circuit 120.

Referring to FIG. 2, the TFT-LCD panel 100 may be a common display for playing an image by the pixel. That is, the TFT-LCD panel 100 may include a backlight 102 and LCD pixels 104. When the backlight 102 is illuminated, the LCD pixels 104 can be controlled in a desired pixel unit, and thus an image can be provided. Furthermore, the transmission of light can be controlled through a polarizer.

The TN-LCD 110 includes segmented parallax barriers and functions to separate pieces of light that penetrate left and right eyes from each other. The segmented parallax barriers, as shown in FIG. 2, may include Parallax Barrier (PB) layers 113 and 114. The layer includes a pair of transparent electrodes (e.g., Indium Tin Oxide (ITO)). A driving voltage is applied to the pair of transparent electrodes.

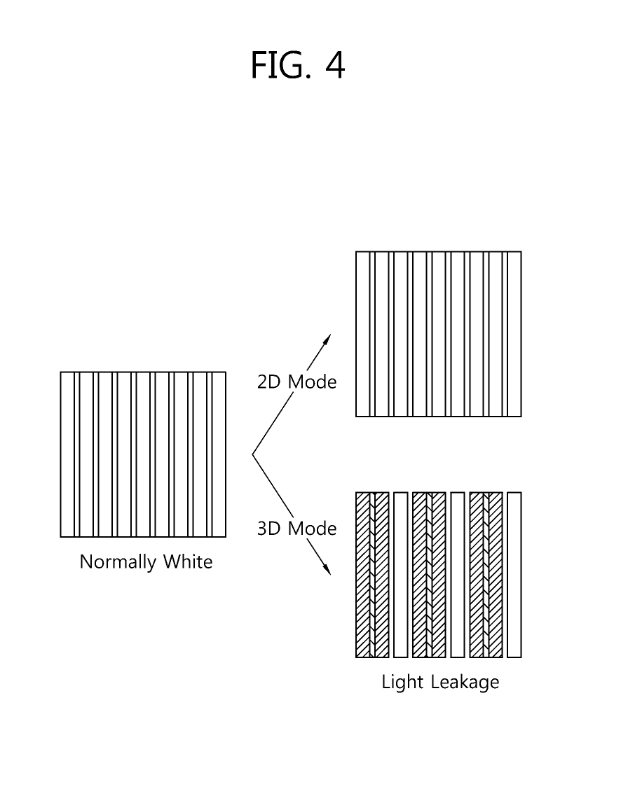

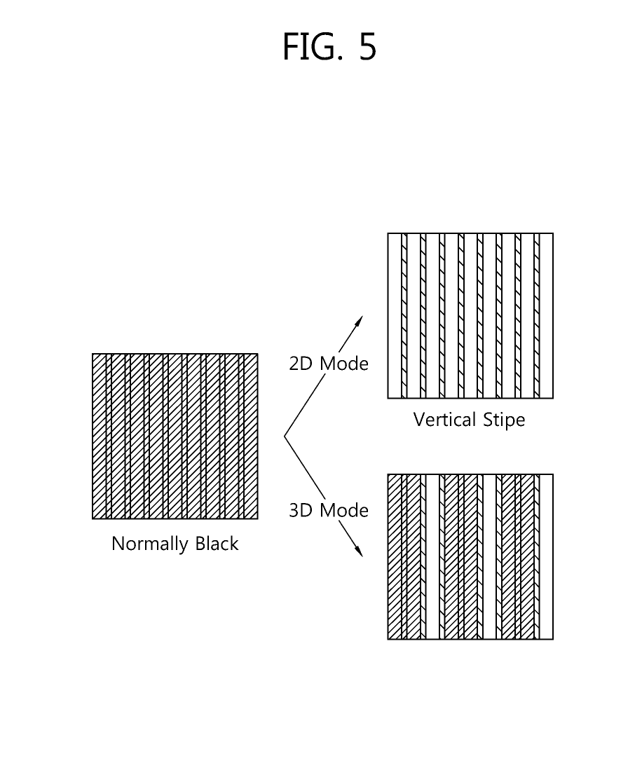

In reality, the liquid crystals of the TN-LCD 110 transmit light generated from the TFT-LCD 100 by playing a 3-D image or the generated light is blocked by the liquid crystals of the TN-LCD 110. The TN-LCD 110 can be driven in normally black mode, that is, a method in which the liquid crystals transmit light when a specific voltage is applied to each transparent electrode (reversely, the liquid crystals block light when voltage is not applied to each transparent electrode), and normally white mode, that is, a method in which the liquid crystals transmit light when voltage is not applied to each transparent electrode (reversely, the liquid crystals block light when voltage is applied to each transparent electrode), depending on the method (refer to FIGS. 4 and 5). As shown in FIG. 2, the driving circuit 120 provides a driving voltage to the segmented parallax barrier 110 based on the location and distance of a user. The driving circuit 120 is connected to the transparent electrodes 113 and 114 having respective patterns through electrodes S1, S2, S3, and S4.

In this case, however, the fine electrodes 113 and 114 located at both ends of the thin-film TN-Liquid Crystals (LCs) of the segmented parallax barrier 110 are made of patterned Indium Tin Oxide (ITO) and are fine transparent electrodes.

As shown in FIG. 2, FIG. 2 shows a shape of the thin-film TN-LCD panel 110 that is seen at the top or bottom when the thin-film TN-LCD panel 110 is set up vertically. It is difficult to wire the fine transparent electrodes in a thin and long space in the horizontal direction of the upright TN-LCD panel 110 on the upper or lower side. Furthermore, in order to uniformly form the barrier patterns over the TN-LCD panel 110, it is necessary to wire the fine transparent electrodes so that a uniform voltage is applied to the fine transparent electrodes.

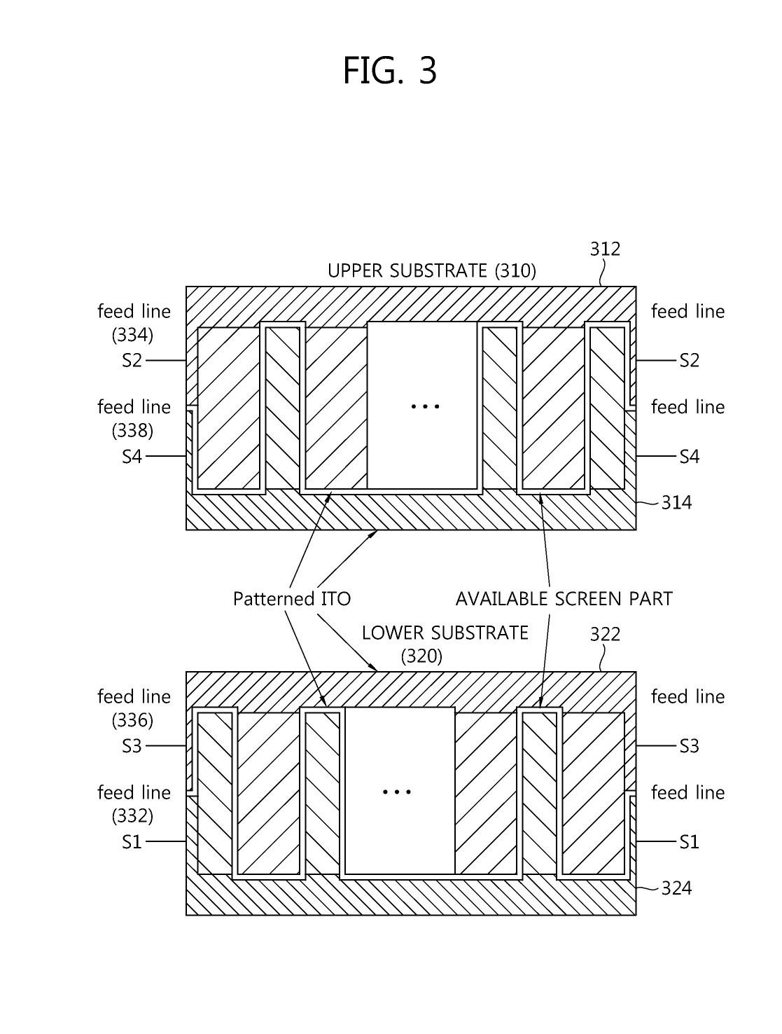

FIG. 3 is a block diagram showing the structure of fine transparent electrodes for forming a segmented parallax barrier in accordance with an embodiment of the present invention. As shown in FIG. 3, the segmented parallax barrier in accordance with an embodiment of the present invention may include an upper substrate 310, a lower substrate 320, and a liquid crystal layer (not shown). The liquid crystal layer, although not shown, may be disposed between the upper substrate 310 and the lower substrate 320.

Referring to FIG. 3, the upper substrate 310 and the lower substrate 320 include fine transparent electrodes 312, 314 and 322, and 324 having specific patterns, respectively. The fine transparent electrodes 312, 314 and 322, 324 are grouped in specific patterns, and electrodes belonging to the same group are connected. Accordingly, an additional feed line may not be necessary. Furthermore, feed lines 333, 338 and 336, 332 for wiring the fine transparent electrodes 312, 314 and 322, 324 are connected at two places at left and right ends of a TN-LCD panel. Accordingly, a uniform voltage can be applied to the entire TN-LCD panel. Here, the fine transparent electrodes 312, 314 and 322, 324 may be made of patterned Indium Tin Oxide (ITO).

More particularly, the upper substrate 310 may include two or more fine transparent electrodes 312 and 314 having patterns belonging to different groups. Likewise, the lower substrate 320 may include two or more fine transparent electrodes 322 and 324 having patterns belonging to different groups. In an embodiment of the present invention, two patterns are illustrated, but the number of patterns does not need to be two, and greater types of patterns may be used.

Fine transparent electrodes having patterns belonging to the same group can be connected to form one electrode without a feed line connected to each fine transparent electrode. That is, the fine transparent electrode 324 configured to have a pattern belonging to a first group and form the lower substrate 320 may be connected to the first feed line 332, and the fine transparent electrode 322 configured to have a pattern belonging to a third group and form the lower substrate 320 may be connected to the third feed line 336. Furthermore, the fine transparent electrode 312 configured to have a pattern belonging to a second group and form the upper substrate 310 may be connected to the second feed line 334, and the fine transparent electrode 314 configured to have a pattern belonging to a fourth group and form the upper substrate 310 may be connected to the fourth feed line 338. Here, the patterns of the first and the third groups may belong to different groups, and the patterns of the second and the fourth groups may belong to different groups.

Furthermore, wiring is efficient because the fine transparent electrodes having different patterns include the feed lines 333, 338 and 336, 332, a feed line is not provided in each fine transparent electrode, and one feed line is provided in each group. The fine transparent electrodes belonging to one group are connected to one feed line, and the feed line is connected to the left and right ends of the TN-LCD panel on both ends. Accordingly, the complexity of wiring can be reduced. Furthermore, a uniform voltage can be applied to the entire TN-LCD panel.

In accordance with the aforementioned embodiment of the present invention, a display panel or a 3-D display apparatus can be configured based on the segmented parallax barrier.

Like a conventional 3-D display apparatus, the 3-D display apparatus may include an image panel (it may include a TFT-LCD panel), a display panel (it may include a TN-LCD panel) including a segmented parallax barrier, and a driving unit.

Here, the image panel can display a left image and a right image so that left image columns and right image columns are alternately displayed. Since the left image columns L and the right image columns R are alternately displayed, the left image and the right image can be displayed on one image panel at the same time. In accordance with an embodiment of the present invention, the image panel may be any of a Liquid Crystal Display (LCD), a Light-Emitting diode Display (LED), an Organic Light Emitting diode Display (OLED), a Plasma Display Panel (PDP), and an Electroluminescent Display (EL). That is, the image panel means a common display device for playing an image by the pixel, but the image panel is not limited to the displays.

The driving unit can drive the fine transparent electrodes of the segmented parallax barrier based on the distance between the image panel and a viewer so that the left image and the right image can be separately viewed.

FIG. 4 is a diagram illustrating a case where TN-LCs operate in normally white mode.

FIG. 4 shows an example in which TN-LCs operate in normally white mode. The liquid crystal layer can operate in normally white mode, that is, a method in which the liquid crystal layer blocks light when voltage is applied to the fine transparent electrodes of the segmented parallax barrier (reversely, the liquid crystal layer transmits light when voltage is not applied to the fine transparent electrodes of the segmented parallax barrier). In this case, light is normally transmitted in 2-D mode, but a phenomenon in which light may leak between a fine gap to which voltage is not applied between barriers to which the voltage is applied may occur in 3-D mode. This phenomenon can be overcome by controlling a polarizer. For example, this light leakage phenomenon can be overcome by including the polarizer in the TFT-LCD panel and the polarizer in the TN-LCD panel and switching the polarization of both the polarizers.

FIG. 5 is a diagram illustrating a case where TN-LCs operate in normally black mode. As shown in FIG. 5, when the TN-LCs operate in normally black mode, the liquid crystal layer operates in normally black mode, that is, a method in which the liquid crystal layer transmits light when voltage is applied to the fine transparent electrodes (reversely, the liquid crystal layer blocks light when voltage is not applied to the fine transparent electrodes. In this case, however, in 3-D mode, a light leakage phenomenon does not occur by applying voltage to only barrier electrodes located at locations through which light will be transmitted and removing the barriers. In 2-D mode, however, power consumption can be increased because the entire 3-D panel area must transmit light by applying voltage to all the barrier electrodes, and a vertical stripe may appear because light is blocked between a fine gap between barrier electrodes to which the voltage is not supplied. The problems can be overcome by controlling a polarizer.

The characteristics of the normally white mode and the normally black mode can be determined depending on the type of liquid crystals used in a liquid crystal layer. In order to properly control a parallax barrier by taking the distance from a viewer's screen and the location of the viewer into consideration, the above characteristics of the liquid crystals may be taken into consideration.

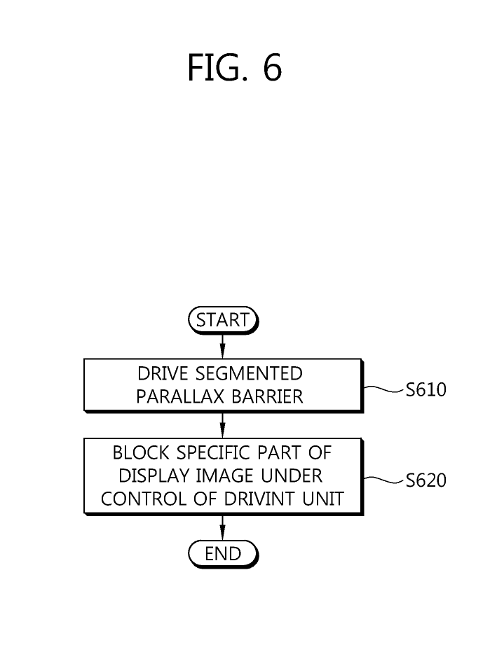

FIG. 6 is a flowchart illustrating a display method of the segmented parallax barrier structure in accordance with an embodiment of the present invention.

Referring to FIG. 6, a display panel based on the segmented parallax barrier structure first drives the segmented parallax barrier at step S610. The segmented parallax barrier is driven under the control of the driving unit because it is connected to the driving unit. The segmented parallax barrier includes fine transparent electrodes grouped in specific patterns, and fine transparent electrodes belonging to the same group are connected. Accordingly, the driving unit can supply voltage to the transparent electrodes without an additional feed line. The segmented parallax barrier may include an upper substrate configured to include fine transparent electrodes having a first pattern and a second pattern and to have the fine transparent electrodes of the first pattern connected to a first feed line and have the fine transparent electrodes of the second pattern connected to a second feed line, a lower substrate configured to include fine transparent electrodes having a third pattern and a fourth pattern and to have the fine transparent electrodes of the third pattern connected to a third feed line and have the fine transparent electrodes of the fourth pattern connected to a fourth feed line, and a liquid crystal layer disposed between the upper and lower substrates. The first to the fourth feed lines may be connected to both ends of the display panel on the left and right sides. Here, the first pattern and the second pattern may belong to different groups, and the third pattern and the fourth pattern may belong to different groups. Furthermore, the fine transparent electrodes may be made of patterned Indium Tin Oxide (ITO).

Next, the display panel based on the segmented parallax barrier structure can block a specific part of a displayed image under the control of the driving unit at step S620. Here, fine transparent electrodes having patterns belonging to the same group may be coupled and connected to both ends of the display panel on the left and right sides. Accordingly, fine transparent electrodes having patterns belonging to a desired group can be easily controlled, and thus a specific part of a displayed image can be efficiently blocked. Here, the liquid crystal layer may operate in such a way as to block light when voltage is applied to the segmented parallax barrier (i.e., normally white mode) or may operate in such a way as to transmit light when voltage is applied to the segmented parallax barrier (i.e., normally black mode).

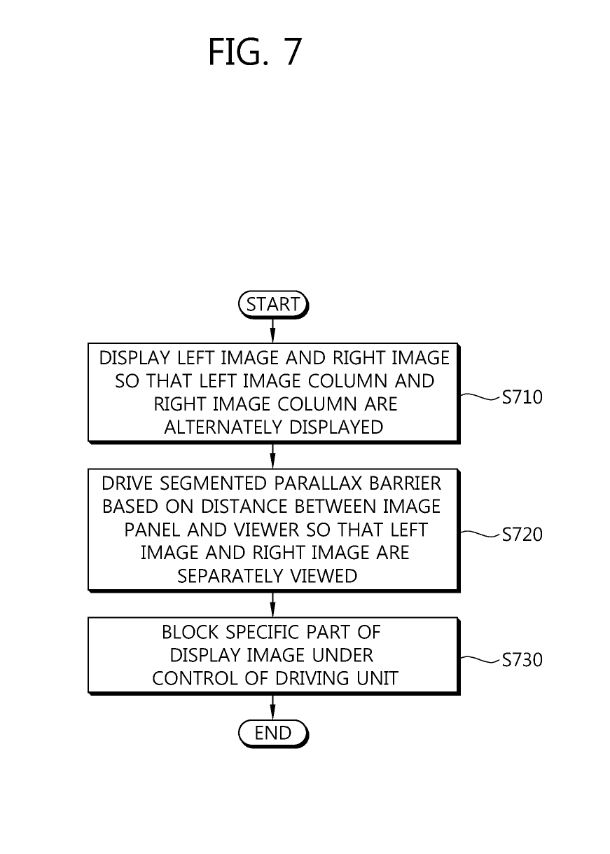

FIG. 7 is a flowchart illustrating a 3-D display method of the segmented parallax barrier structure in accordance with an embodiment of the present invention.

As shown in FIG. 7, in the 3-D display method based on the segmented parallax barrier in accordance with an embodiment of the present invention, first, the image panel may display a left image and a right image so that left image columns and right image columns are alternately displayed at step S710. Here, the image panel may be any of a Liquid Crystal Display (LCD), a Light-Emitting diode Display (LED), an Organic Light Emitting diode Display (OLED), a Plasma Display Panel (PDP), and an Electroluminescent Display (EL). That is, the image panel may include a common display device for playing an image by the pixel. Next, the driving unit can drive the segmented parallax barrier based on the distance between the image panel and a viewer so that the left image and the right image can be separately viewed at step S720. Here, the segmented parallax barrier includes fine transparent electrodes grouped in specific patterns, and fine transparent electrodes belonging to the same group are connected. Accordingly, the fine transparent electrodes can be supplied with voltage from the driving unit without an additional feed line.

When the fine transparent electrodes of the segmented parallax barrier are driven under the control of the driving unit, the segmented parallax barrier can block a specific part of a displayed image so that the viewer can separately view the left image and the right image and thus view a 3-D image at step S730. In accordance with an embodiment of the present invention, the driving unit can drive the fine transparent electrodes of the segmented parallax barrier based on the distance between the image panel and the viewer so that the view can separately view the left image and the right image.

The detailed characteristics of the 3-D display method based on the segmented parallax barrier in accordance with an embodiment of the present invention comply with the 3-D display apparatus based on the segmented parallax barrier in accordance with an embodiment of the present invention.

In accordance with the display panel, the 3-D display apparatus, and the display method based on the segmented parallax barrier according to the present invention are advantageous in that the production cost of a TN-LCD panel based on a segmented parallax barrier can be reduced and a TN-LCD panel having excellent barrier pattern characteristics can be easily manufactured.

Although the present invention has been described in connection with the drawings and embodiments, the scope of the present invention is not limited to the drawings and embodiments. A person having ordinary skill in the art will appreciate that the present invention may be modified and changed in various ways without departing from the spirit and scope of the present invention which are written in the claims below.

What is claimed is:

1. A display panel based on a segmented parallax barrier, comprising:
the segmented parallax barrier disposed in a front or back of an image panel and configured to block a specific part of an image displayed through the image panel; and
wherein the segmented parallax barrier is configured to connect fine transparent electrodes belonging to an identical group through a transparent electrode, from among fine transparent electrodes grouped in specific patterns, so that voltage is supplied to the fine transparent electrodes without an additional feed line assigned to each fine transparent electrode.

2. The display panel of claim 1, wherein the segmented parallax barrier comprises:
an upper substrate configured to comprise fine transparent electrodes having a first pattern and a second pattern and to have fine transparent electrodes of the first pattern connected to a first feed line and have the fine transparent electrodes of the second pattern connected to a second feed line;
a lower substrate configured to comprise fine transparent electrodes having a third pattern and a fourth pattern and to have fine transparent electrodes of the third pattern connected to a third feed line and have the fine transparent electrodes of the fourth pattern connected to a fourth feed line; and
a liquid crystal layer disposed between the upper and lower substrates.

3. The display panel of claim 2, wherein the first to the fourth feed lines are connected to both ends of the display panel on left and right sides.

4. The display panel of claim 2, wherein:
the first pattern and the second pattern belong to different groups, and
the third pattern and the fourth pattern belong to different groups.

5. The display panel of claim 1, wherein the fine transparent electrodes are made of patterned Indium Tin Oxide (ITO).

6. The display panel of claim 1, wherein the segmented parallax barrier operates in normally white mode in which a liquid crystal layer of the segmented parallax barrier blocks light when voltage is supplied to the fine transparent electrode.

7. The display panel of claim 1, wherein the segmented parallax barrier operates in normally black mode in which a liquid crystal layer of the segmented parallax barrier transmits light when voltage is supplied to the fine transparent electrode.

8. A 3-D display apparatus based on a segmented parallax barrier, comprising:
an image panel configured to display a left image and a right image so that left image columns and right image columns are alternately displayed;
the segmented parallax barrier disposed in a front or back of the image panel and configured to block a specific part of a displayed image; and
a driving unit configured to drive the segmented parallax barrier based on a distance between the image panel and a viewer so that the left image and the right image are separately viewed,
wherein the segmented parallax barrier is configured to connect fine transparent electrodes belonging to an identical group through a transparent electrode, from among fine transparent electrodes grouped in specific patterns, so that voltage is supplied to the fine transparent electrodes without an additional feed line.

9. The 3-D display apparatus of claim 8, wherein the segmented parallax barrier comprises:
an upper substrate configured to comprise fine transparent electrodes having a first pattern and a second pattern and to have fine transparent electrodes of the first pattern connected to a first feed line and have the fine transparent electrodes of the second pattern connected to a second feed line;
a lower substrate configured to comprise fine transparent electrodes having a third pattern and a fourth pattern and to have fine transparent electrodes of the third pattern connected to a third feed line and have the fine transparent electrodes of the fourth pattern connected to a fourth feed line; and
a liquid crystal layer disposed between the upper and lower substrates.

10. The 3-D display apparatus of claim 9, wherein the first to the fourth feed lines are connected to both ends of a display panel on left and right sides which comprises the segmented parallax barrier.

11. A display method based on a segmented parallax barrier, comprising:
a driving unit driving the segmented parallax barrier; and
the segmented parallax barrier blocking a specific part of a displayed image under control of the driving unit,
wherein the segmented parallax barrier is configured to connect fine transparent electrodes belonging to an identical group through a transparent electrode, from among fine transparent electrodes grouped in specific patterns, so that voltage is supplied to the fine transparent electrodes without an additional feed line.

12. The display method of claim 11, wherein the segmented parallax barrier comprises:
an upper substrate configured to comprise fine transparent electrodes having a first pattern and a second pattern and to have fine transparent electrodes of the first pattern connected to a first feed line and have the fine transparent electrodes of the second pattern connected to a second feed line;
a lower substrate configured to comprise fine transparent electrodes having a third pattern and a fourth pattern and to have fine transparent electrodes of the third pattern connected to a third feed line and have the fine transparent electrodes of the fourth pattern connected to a fourth feed line; and
a liquid crystal layer disposed between the upper and lower substrates.

13. The display method of claim 12, wherein the first to the fourth feed lines are connected to both ends of the display panel on left and right sides.

14. The display method of claim 12, wherein:
the first pattern and the second pattern belong to different groups, and
the third pattern and the fourth pattern belong to different groups.

15. The display method of claim 11, wherein the fine transparent electrodes are made of patterned Indium Tin Oxide (ITO).

16. The display method of claim 11, wherein the segmented parallax barrier blocking a specific part of a displayed image under control of the driving unit comprises driving the segmented parallax barrier in normally white mode in which a liquid crystal layer of the segmented parallax barrier blocks light when voltage is supplied to the fine transparent electrode.

17. The display method of claim 11, wherein the segmented parallax barrier blocking a specific part of a displayed image under control of the driving unit comprises driving the segmented parallax barrier in normally black mode in which a liquid crystal layer of the segmented parallax barrier transmits light when voltage is supplied to the fine transparent electrode.

18. A 3-D display method based on a segmented parallax barrier, comprising:
an image panel displaying a left image and a right image so that left image columns and right image columns are alternately displayed;
a driving unit driving the segmented parallax barrier based on a distance between the image panel and a viewer so that the left image and the right image are separately viewed; and
the segmented parallax barrier blocking a specific part of the displayed image under control of the driving unit,
wherein the segmented parallax barrier is configured to connect fine transparent electrodes belonging to an identical group through a transparent electrode, from among fine transparent electrodes grouped in specific patterns, so that voltage is supplied to the fine transparent electrodes without an additional feed line.

19. The 3-D display method of claim 18, wherein the segmented parallax barrier comprises:
an upper substrate configured to comprise fine transparent electrodes having a first pattern and a second pattern and to have fine transparent electrodes of the first pattern connected to a first feed line and have the fine transparent electrodes of the second pattern connected to a second feed line;
a lower substrate configured to comprise fine transparent electrodes having a third pattern and a fourth pattern and to have fine transparent electrodes of the third pattern connected to a third feed line and have the fine transparent electrodes of the fourth pattern connected to a fourth feed line; and
a liquid crystal layer disposed between the upper and lower substrates.

20. The 3-D display method of claim 19, wherein the first to the fourth feed lines are connected to both ends of a display panel on left and right sides which comprises the segmented parallax barrier.
